(19) United States
(12) Patent Application Publication
(10) Pub. No.: US 2011/0196745 A1
(43) Pub. Date: Aug. 11, 2011

(54) ELECTRONIC ADVERTISEMENT SYSTEM, ELECTRONIC ADVERTISEMENT DISTRIBUTION APPARATUS, ELECTRONIC ADVERTISEMENT DISTRIBUTION METHOD, AND RECORDING MEDIUM

(76) Inventor: Atsushi Moriya, Tokyo (JP)

(21) Appl. No.: 13/125,498

(22) PCT Filed: Nov. 10, 2009
(86) PCT No.: PCT/JP2009/069116

§ 371 Date: Apr. 21, 2011

(30) Foreign Application Priority Data
Nov. 10, 2008 (JP) 2008-288285

(51) Int. Cl. G06Q 30/00

(52) U.S. Cl. 705/14.67

(57) ABSTRACT

An electronic advertisement apparatus (2 to 5) includes a camera (6 to 9) that picks up an image of a viewer who views an advertisement image, and comprises a viewer information recording apparatus (11) that records image information of a facial part of a viewer picked up any one of the electronic advertisement apparatuses (2 to 5), information for specifying an advertisement image viewed by the viewer, and information for specifying any one of the electronic advertisement apparatuses (2 to 5), a facial image checking apparatus (12) that checks an image of the facial part of the viewer with image information recorded in the viewer information recording device (11) when another electronic advertisement apparatus (2 to 5) picks up an image of the viewer, and an advertisement distribution apparatus (13) that causes another electronic advertisement apparatus (2 to 5) to display the same advertisement image as an advertisement image viewed by the viewer when the facial image checking apparatus (11) determines that the viewer picked up by any one of the electronic advertisement apparatuses (2 to 5) is the same person as the viewer picked up by another electronic advertisement apparatus (2 to 5).

### TECHNICAL FIELD

The present invention relates to an electronic advertisement system which tracks a viewer who has viewed an advertisement image, and which displays the same advertisement image on an electronic advertisement apparatus arranged at a location where the viewer moves, an electronic advertisement distribution apparatus, an electronic advertisement distribution method and a recording medium used for the electronic advertisement system.

### BACKGROUND ART

It is known that an apparatus called an electronic advertisement apparatus or a digital signage is arranged at a store, etc., and an advertisement image is presented to customers visiting that store (see, for example, patent literature 1). The electronic advertisement apparatus includes an image display device (e.g., a liquid crystal display device), and displays an advertisement image that is stored in the electronic advertisement apparatus or distributed from an antecedence distribution apparatus on the image display device.

Moreover, FIG. 9 of Patent Literature 1 discloses that a digital signage is provided with a camera and an image of a viewer viewing the digital signage is picked up.

### PRIOR ART DOCUMENT

### Patent Literature

Patent Literature 1: Unexamined Japanese Patent Application KOKAI Publication No. 2005-251170

### SUMMARY OF THE INVENTION

### Problem to be Solved by the Invention

Such electronic advertisement apparatus is capable of presenting a motion image, so that the appeal power thereof is large in comparison with a still image like a poster. However, it is a rare case in which customers entering in a store stay at a specific digital signage, and continuously view all chapters of an advertisement image displayed on that digital signage. Hence, there is a demand for accomplishing a large advertisement effect by, for example, letting the customers moving in the store to view the advertisement image repeatedly and by giving a large impact to the customers.

The present invention has been made in view of the foregoing circumstance, and it is an object of the present invention to provide an electronic advertisement system, etc., that is capable of giving a larger impact to a customer.

### Means for Solving the Problem

An electronic advertisement system according to the present invention is connected to a plurality of electronic advertisement apparatuses each of which displays an advertisement image, wherein the electronic advertisement apparatus includes an image pickup unit that picks up an image of a viewer who views an advertisement image, the electronic advertisement system comprises: a viewer information recording unit that records an image of a facial part of a viewer picked up by the electronic advertisement apparatus, information for specifying an advertisement image viewed by the viewer, and information for specifying the electronic advertisement apparatus; a facial image checking unit that checks an image of the facial part of the viewer with image information recorded in the viewer information recording unit when the electronic advertisement apparatus picks up an image of the viewer; and an advertisement image control unit that causes another electronic advertisement apparatus to display an advertisement image related to an advertisement image viewed by a person of an image recorded in the viewer information recording unit when the facial image checking unit determines that the viewer picked up by the electronic advertisement apparatus is a same person as the person of the image recorded in the viewer information recording unit.

An electronic advertisement distribution apparatus according to the present invention is connected to a plurality of electronic advertisement apparatuses each of which displays an advertisement image, and the electronic advertisement distribution apparatus comprises: a viewer information recording unit that records an image of a facial part of a viewer of the electronic advertisement apparatus, information for specifying an advertisement image viewed by the viewer, and information for specifying the electronic advertisement apparatus; a facial image checking unit that checks an image of the facial part of the viewer with image information recorded in the viewer information recording unit; and an advertisement image control unit that causes another electronic advertisement apparatus to display an advertisement image related to an advertisement image viewed by a person of an image recorded in the viewer information recording unit when the facial image checking unit determines that the viewer picked up by the electronic advertisement apparatus is a same person as the person of the image recorded in the viewer information recording unit.

An electronic advertisement distribution method according to the present invention is of distributing an electronic advertisement to a plurality of electronic advertisement apparatuses each of which displays an advertisement image, and the electronic advertisement distribution method comprises: a viewer information recording step of recording an image of a facial part of a viewer, information for specifying an advertisement image viewed by the viewer, and information for specifying the electronic advertisement apparatus; a facial image checking step of checking an image of the facial part of the viewer with image information recorded in the viewer information recording step; and an advertisement image control step of causing another electronic advertisement apparatus to display an advertisement image related to an advertisement image viewed by a person of an image recorded in the viewer information recording step when it is determined in the facial image checking unit step that the viewer picked up by the electronic advertisement apparatus is a same person as the person of the image recorded in the viewer information recording unit.

A computer-readable recording medium according to the present invention stores a program which is installed in a computer connected to a plurality of electronic advertisement apparatuses each of which displays an advertisement image, and the program allows the computer to function as: a viewer information recording unit that records an image of a facial part of a viewer of the electronic advertisement apparatus, information for specifying an advertisement image viewed by the viewer, and information for specifying the electronic advertisement apparatus; a facial image checking unit that checks an image of the facial part of the viewer with image information recorded in the viewer information recording unit; and an advertisement image control unit that causes another electronic advertisement apparatus to display an advertisement image related to an advertisement image viewed by a person of an image recorded in the viewer information recording unit when the facial image checking unit determines that the viewer picked up by the electronic advertisement apparatus is a same person as the person of the image recorded in the viewer information recording unit.

### Effect of the Invention

According to the electronic advertisement system of the present invention, when a viewer who has viewed an advertisement image on an electronic advertisement apparatus leaves that electronic advertisement apparatus and stops by another electronic advertisement apparatus, the same advertisement image as the advertisement image viewed on the former electronic advertisement apparatus is displayed on another electronic advertisement apparatus, so that a remarkable impact for the advertisement image can be given to the viewer.

### BRIEF DESCRIPTION OF DRAWINGS

FIG. 1 is a layout diagram of a schematic store provided with an electronic advertisement system according to an embodiment of the present invention;

FIG. 2 is a schematic configuration diagram of the electronic advertisement system;

FIG. 3 is a diagram showing an illustrative configuration of viewing information;

FIG. 4 is a diagram showing an illustrative configuration of an advertisement distribution apparatus;

FIG. 5 is a diagram showing an illustrative configuration of schedule information;

FIG. 6 is a diagram showing an illustrative configuration of advertisement image information;

FIG. 7 is a flowchart for explaining a checking-process operation;

FIG. 8 is a flowchart for explaining an advertisement replacing process; and

FIG. 9 is a diagram showing another illustrative configuration of advertisement image information.

### BEST MODE FOR CARRYING OUT THE INVENTION

An explanation will now be given of an electronic advertisement system according to the best mode for carrying out the present invention below.

The embodiment below is for facilitating understanding of the basis of the present invention, and the scope and the spirit of the present invention are not limited to the embodiment below, and are not limited thereto. Other embodiments in which those skilled in the art replace the configuration of the embodiment appropriately are also included in the scope and the spirit of the present invention.

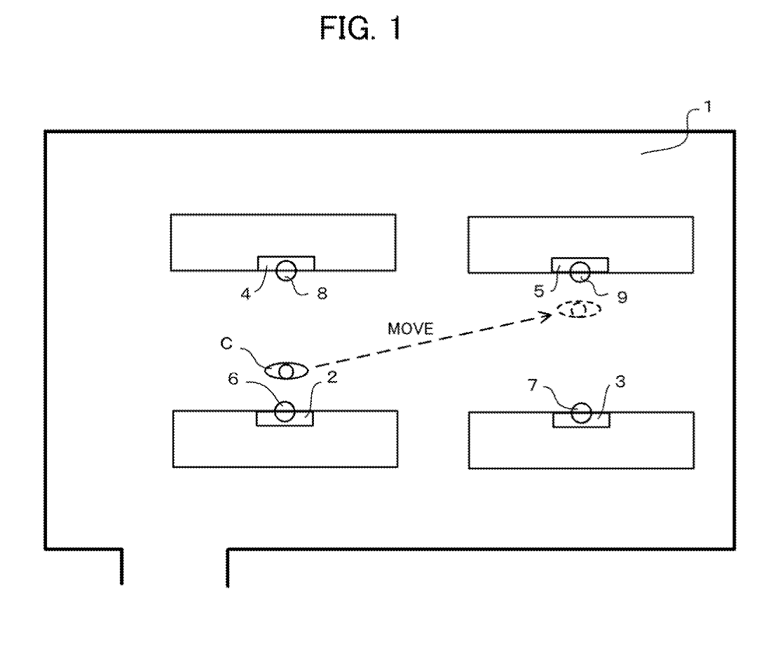

FIG. 1 is a schematic layout diagram of a store 1 having an electronic advertisement system according to an embodiment of the present invention.

As shown in FIG. 1, plural electronic advertisement apparatuses 2 to 5 are arranged in the store 1, and a customer C can freely move in the store 1, and can freely view advertisement images displayed on respective electronic advertisement apparatuses 2 to 5. Moreover, the electronic advertisement apparatuses 2 to 5 have cameras 6 to 9, respectively, and can pick up an image of a facial part of the customer C viewing an advertisement image.

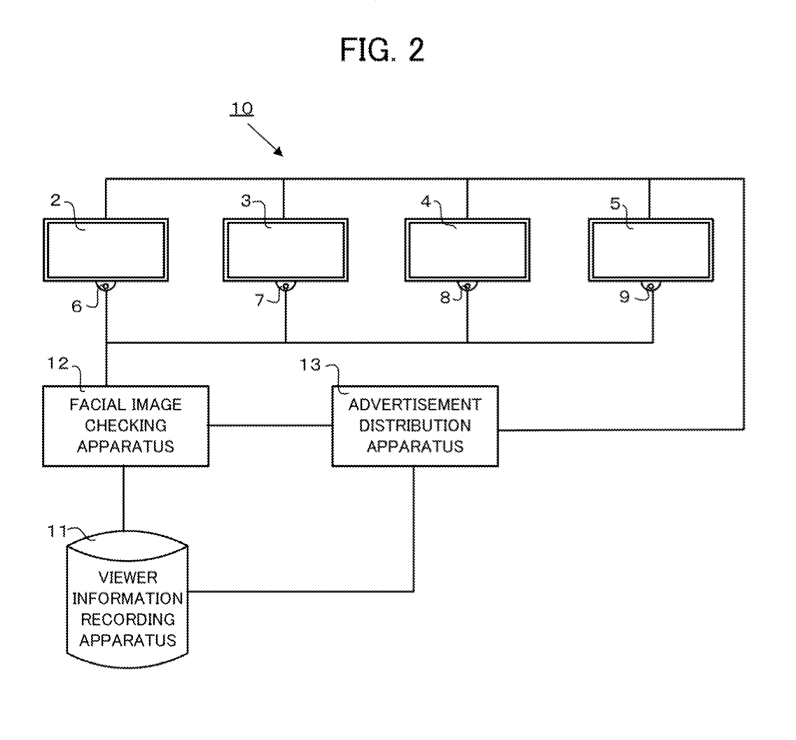

FIG. 2 is a diagram showing a schematic configuration of the electronic advertisement system. The electronic advertisement apparatuses 2 to 5 arranged in the store 1 and the cameras 6 to 9 are components of the electronic advertisement system 10, and the electronic advertisement system 10 employs a configuration shown in FIG. 2. That is, the electronic advertisement system 10 includes the electronic advertisement apparatuses 2 to 5, a viewer information recording apparatus 11, a facial image checking apparatus 12 and an advertisement distribution apparatus 13.

The electronic advertisement apparatuses 2 to 5 each include a display device like a liquid crystal display device, and a speaker, etc., and outputs arbitrary contents (images and/or sounds). The electronic advertisement apparatuses 2 to 5 have the cameras 6 to 9, respectively.

The cameras 6 to 9 each comprise a CCD (Charge Coupled Device) camera, etc., and have a field angle set so that an image of the face of the customer C stopping by and watching the screens of respective advertisement apparatuses 2 to 5 is picked up. The cameras 6 to 9 are set at respective arbitrary positions which enable image pickup of the facial part of the customer C.

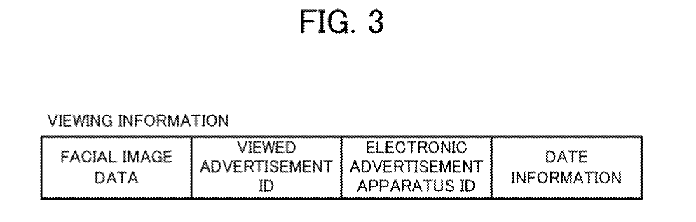

The viewer information recording apparatus 11 stores viewing information of the customer C who viewed an advertisement image displayed on each of the electronic advertisement apparatuses 2 to 5. FIG. 3 is a diagram showing an illustrative configuration of the viewing information stored in the viewer information recording apparatus 11. As shown in FIG. 3, the viewing information includes image data (facial image data) of an image of the facial part of the customer C viewing an advertisement image displayed on each of the electronic advertisement apparatuses 2 to 5, identification information (viewed advertisement ID) of an advertisement image viewed by the customer C, identification information (electronic advertisement apparatus ID) of each of the electronic advertisement apparatuses 2 to 5, and data information indicating the date at which the advertisement was viewed.

The facial image checking apparatus 12 is a computer that comprises a processor, etc., checks the image of the facial part of the customer C picked up by each of the cameras 6 to 9 with the facial image recorded in the viewer information recording apparatus 11, and outputs an advertisement replacing instruction to the advertisement distribution apparatus 13 when the facial image of the same person as the facial image of the customer C picked up by each of the cameras 6 to 9 is recorded in the viewer information recording apparatus 11.

The advertisement distribution apparatus 13 stores advertisement images, distributes advertisement images to the electronic advertisement apparatuses 2 to 5 in accordance with a predetermined schedule, and causes such electronic advertisement apparatuses to display the advertisement images. Moreover, when an advertisement replacing instruction is input by the facial image checking apparatus 12, the advertisement distribution apparatus 13 interrupts distribution of the advertisement image in accordance with the schedule, but distributes the same advertisement image as the advertisement image recorded in the viewer information recording apparatus 11 to any corresponding one of the electronic advertisement apparatuses 2 to 5.

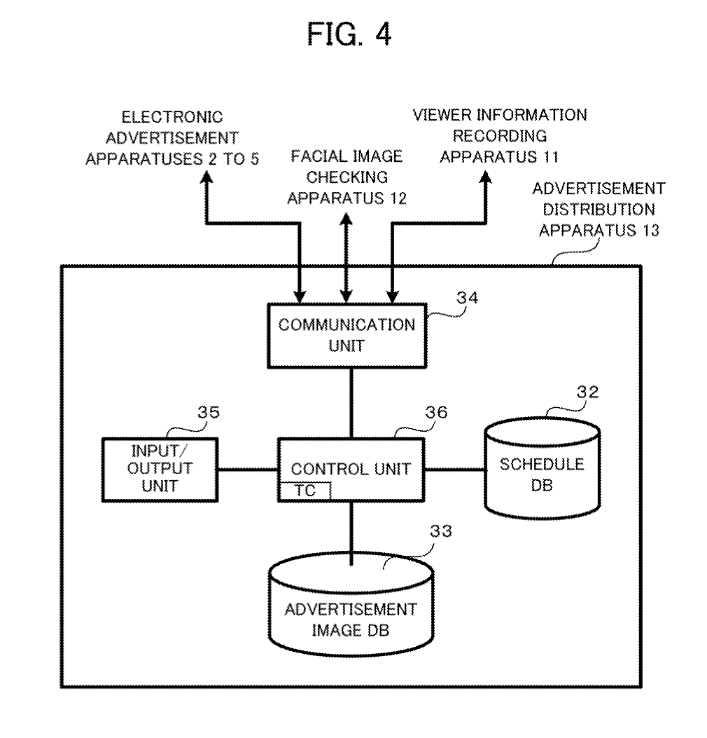

FIG. 4 shows the illustrative configuration of the advertisement distribution apparatus 13. As shown in the figure, the advertisement distribution apparatus 13 includes a schedule database (DB) 32, an advertisement image DB 33, a communication unit 34, an input/output unit 35, and a control unit 36.

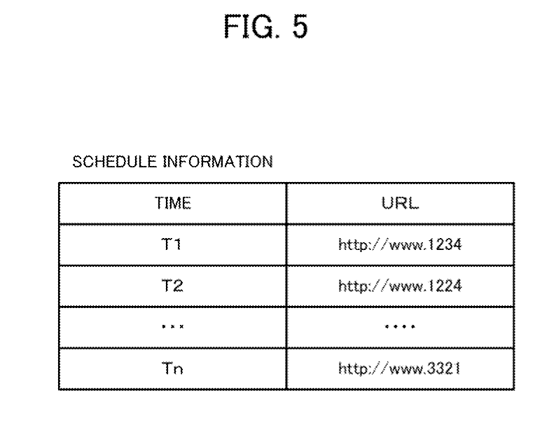

The schedule DB 32 stores a schedule of distributing (displaying) an advertisement for each electronic advertisement apparatus. FIG. 5 is a diagram showing an illustrative configuration of the schedule information stored in the schedule DB 32. As shown in FIG. 5, the distribution schedule includes a time (hour, minute, and second), and an address (URL (Uniform Resource Locator) of a location where an advertisement image (e.g., a motion image with sounds) to be displayed is stored.

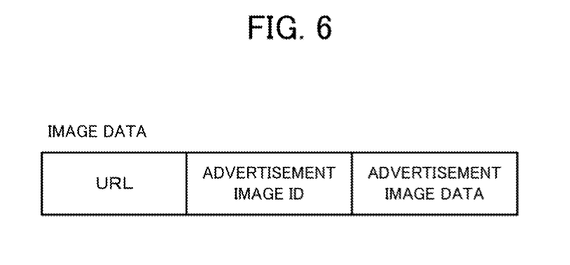

The advertisement image DB 33 stores image data (e.g., a motion image with sounds in an MPEG format) of an advertisement image to be displayed. FIG. 6 is a diagram showing an illustrative configuration of the advertisement image information stored in the advertisement image DB 33. Each piece of image data configuring the advertisement image is specified by a URL as shown in FIG. 6. The distribution schedule specifies the image data to be distributed based on the URL. Each advertisement image is associated with an ID (image ID).

The communication unit 34 communicates with the electronic advertisement apparatuses 2 to 5, the viewer information recording apparatus 11, and the facial image checking apparatus 12, etc.

The input/output unit 35 includes a keyboard, a mouse, and a display device, etc., inputs various instructions and data into the control unit 36, and displays an output by the control unit 36.

The control unit 36 comprises a processor, and the like, has an RTC (Real Time Clock), and operates in accordance with a control program. More specifically, the control unit 36 reads an advertisement image to be displayed on each of the electronic advertisement apparatuses 2 to 5 from the advertisement image DB 33 in accordance with the distribution schedule registered in the schedule DB 32, and supplies the read advertisement image through a communication line from the communication unit 34. Moreover, the control unit 36 selects an advertisement image stored in the advertisement image DB 33 in response to an instruction by the facial image checking apparatus 12, and transmits the selected advertisement image to a designated one of electronic advertisement devices 2 to 5.

Furthermore, the control unit 36 edits and updates the distribution schedule in response to an instruction given by the input/output unit 35.

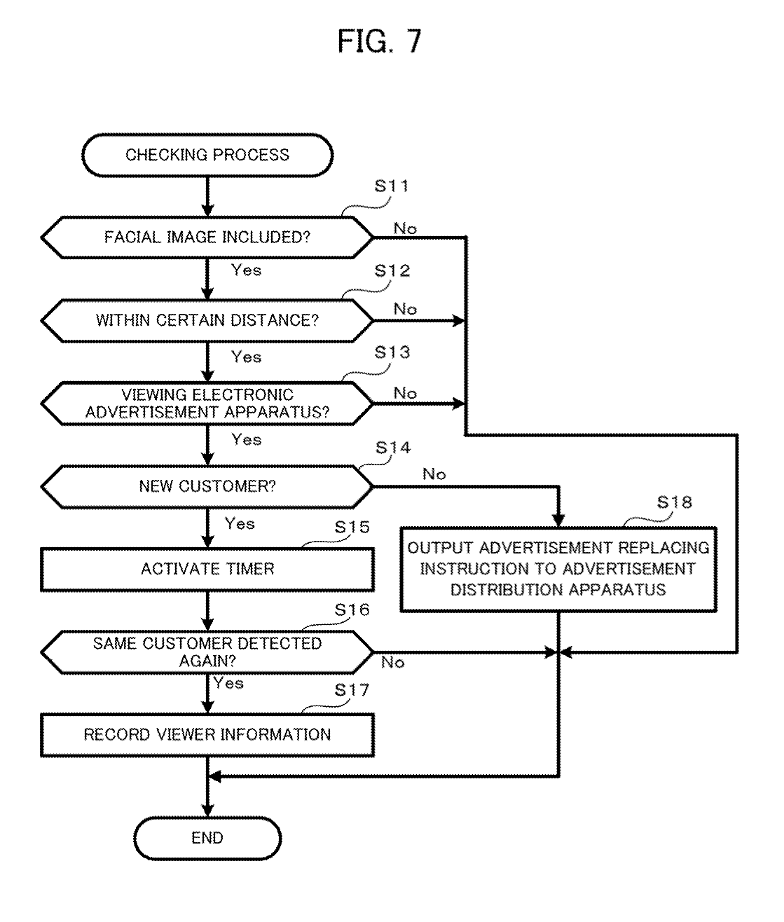

Next, an explanation will be given of an operation of the electronic advertisement system 10 having the above configuration. FIG. 7 is a flowchart showing a checking process executed by the electronic advertisement system 10 according to the embodiment.

First, before starting a checking process, the control unit 36 of the advertisement distribution apparatus 13 reads an advertisement image to be displayed from the advertisement image DB 33 in accordance with a current time clocked by the RTC and the schedule registered in the schedule DB 32, and supplies the read advertisement image to the electronic advertisement apparatuses 2 to 5. Each of the electronic advertisement apparatuses 2 to 5 displays the supplied advertisement image.

On the other hand, each of the cameras 6 to 9 provided at each of the electronic advertisement apparatuses 2 to 5 picks up an image ahead of each electronic advertisement apparatus, and obtains a frame image at a frame cycle of, for example, 1/30 seconds, and transmits the frame image to the facial image checking apparatus 12.

When receiving frame images from the cameras 6 to 9 provided at respective electronic advertisement apparatuses 2 to 5, the facial image checking apparatus 12 executes a process shown in FIG. 7 for each received frame image.

An explanation will be given below of a checking process when, for example, the frame image received from the camera 6 provided at the electronic advertisement apparatus 2 is checked.

First, the facial image checking apparatus 12 determines whether or not an image of a face is included in each supplied frame image through a pattern recognizing technique, etc. (step S11). In the step S11, it is fine if determination on whether or not the image of the face of the customer C is included in the image (the frame image) picked up by the camera 6 can be carried out, and an arbitrary pattern recognizing technique can be applied.

When determining that the image of a face is included (step S11: YES), the facial image checking apparatus 12 determines whether or not the customer C is located within a predetermined distance from the electronic advertisement apparatus 2 (step S12).

Whether or not the customer C is located within a predetermined distance from the electronic advertisement apparatus 2 can be determined based on whether or not the size of the face on the frame image is equal to or larger than a predetermined reference value. Moreover, whether or not the customer C is watching the electronic advertisement apparatus 2 can be determined based on, for example, whether or not a pair of two black points (estimated as images of eyes) located within a certain distance (e.g., 10 to 18 cm) in the image of the face can be extracted. Furthermore, such determination can be carried out by checking whether or not the distance between the customer C and the electronic advertisement apparatus 2 (or the camera 6) is within a predetermined distance using an infrared distance sensor, etc.

When determining that the customer C is located within a predetermined distance (step S12: YES), the facial image checking apparatus 12 determines whether or not the customer C is viewing (paying attention to) the electronic advertisement apparatus 2 (step S13).

When determining that no image of a face is included in each supplied frame image (step S11: NO), when determining that the customer C is distant from the electronic advertisement apparatus 2 at equal to or longer than the predetermined distance (step S12: NO), or when determining that the customer C is not viewing (not paying attention to) the electronic advertisement apparatus 2 (step S13: NO), the facial image checking apparatus 12 terminates the process.

When determining in the step S13 that the customer C is viewing the electronic advertisement apparatus 2 (step S13: YES), the facial image checking apparatus 12 checks the facial image (hereinafter, referred to as a “new facial image”) of the customer C with an image (hereinafter, referred to as an “old facial image”) recorded in the viewer information recording apparatus 11, and determines whether or not there is a matching image, i.e., whether or not it is a new customer (step S14).

In the step S14, when the new facial image does not match any one of the old facial images stored in the viewer information recording apparatus 11, i.e., the new facial image is a facial image of a person newly detected by the electronic advertisement system 10 (step S14: YES), the control unit 36 starts (activates) a timer (step S15). The control unit 36 receives a determination result by the facial image checking apparatus 12 through the communication unit 34, and activates the timer. The timer is caused to count a time, and after a predetermined time elapses, a process in step S16 to be discussed later is executed.

The facial image checking apparatus 12 may have a timer function, and by controlling activation/stopping of such a timer, a time can be counted.

After the predetermined time has elapsed, the facial image checking apparatus 12 determines whether or not the camera 6 provided at the electronic advertisement apparatus 2 is detecting the same customer C (step S16).

After the predetermined time has elapsed or after the time counted by the timer has been up, when the camera 6 does not detect the same customer C (step S16: NO), i.e., when the customer C left the electronic advertisement apparatus 2 before the predetermined time has elapsed, the process is terminated as it is without any action.

Conversely, when the camera 6 is still detecting the same customer C (step S16: YES), i.e., the customer C is staying at the electronic advertisement apparatus 2 for a predetermined time, and is viewing the advertisement image, the facial image checking apparatus 12 records the image (the new facial image) of the facial part of the customer C picked up by the camera 6, the ID of the advertisement image viewed (browsed) by the customer C over the electronic advertisement apparatus 2, and the identification code of the electronic advertisement apparatus 2 in the viewer information recording apparatus 11 (step S17). When the customer C is viewing the advertisement image over the predetermined time, there is a high possibility that the customer C has an interest to the advertisement image.

In the step S17, when the same advertisement image is viewed over the same electronic advertisement apparatus for each same facial image, i.e., when the customer C stays at the electronic advertisement apparatus 2 and keeps viewing the advertisement image, viewer information is not updated, but when any information changes, the viewer information may be overwritten or additionally updated.

In the step S14, when the new facial image is substantially same as any one of the old facial images (step S14: NO), i.e., when the customer C and any one of the persons of the old facial images are same, the facial image checking apparatus 12 outputs an advertisement replacing instruction to the advertisement distribution apparatus 13 (step S18), and terminates the process. This instruction includes a viewed advertisement ID and an electronic advertisement apparatus ID.

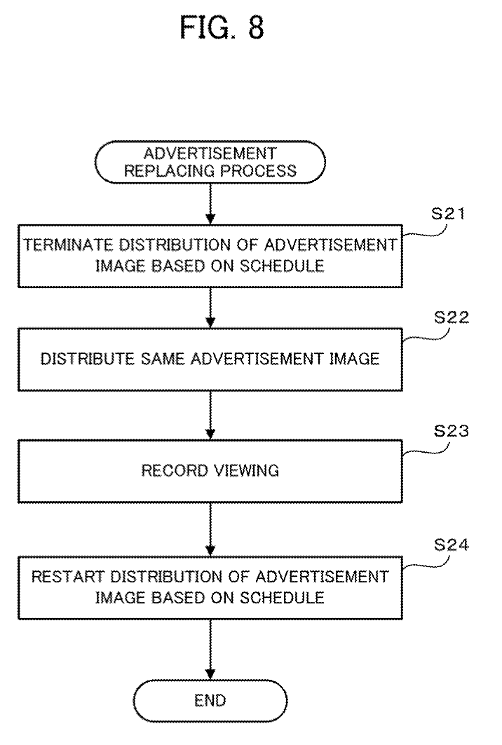

The advertisement distribution apparatus 13 which has received the advertisement replacing instruction executes an advertisement replacing process program shown in FIG. 8. As explained above, while the electronic advertisement system 10 is in operation, the advertisement distribution apparatus 13 distributes various advertisement images to the electronic advertisement apparatuses 2 to 5 in accordance with the predetermined schedule, but when the advertisement replacing instruction is input into the advertisement distribution apparatus 13 from the facial image checking apparatus 12, this replacing process is interruptingly executed.

Next, an explanation will be given of an operation of replacing the advertisement image. FIG. 8 is a flowchart showing an advertisement replacing process executed by the advertisement distribution apparatus 13 according to this embodiment.

First, upon reception of the advertisement replacing instruction from the facial image checking apparatus 12, the control unit 36 of the advertisement distribution apparatus 13 executes an advertisement replacing process program. As shown in FIG. 8, the control unit 36 terminates distribution of the advertisement image to the electronic advertisement apparatus (in the embodiment, the electronic advertisement apparatus 2) specified by the electronic advertisement apparatus ID included in the advertisement replacing instruction (having the camera picked up the new facial image) which is based on the schedule (step S21).

Next, the control unit 36 reads an advertisement image specified by a viewed advertisement ID included in the advertisement replacing instruction from the advertisement image DB 33, and distributes that advertisement image to the electronic advertisement apparatus 2 which is specified by the electronic advertisement apparatus ID included in the advertisement replacing instruction. That is, the control unit 36 distributes the same advertisement image as the advertisement image recorded in the viewer information recording apparatus 11 (the advertisement image viewed by the customer C on any one of the electronic advertisement apparatuses 2 to 5 before the customer comes up to the electronic advertisement apparatus 2) and causes the electronic advertisement apparatus 2 to display that advertisement image (step S22).

Next, the control unit 36 records information to the effect that the viewer C has viewed the same advertisement image on the electronic advertisement apparatus 2 in the viewer information recording apparatus 11 (step S23). When the display of the same advertisement image on the electronic advertisement apparatus 2 completes, the control unit restarts distribution of the advertisement image based on the predetermined schedule (step S24), and terminates the process.

As explained above, according to the electronic advertisement system 10, when the customer C views an advertisement image over a predetermined time on any one of the electronic advertisement apparatuses 2 to 5 in the store 1 where the plural electronic advertisement apparatuses 2 to 5 are arranged, if the customer C moves and comes up to another electronic advertisement apparatus, the electronic advertisement system 10 detects this, and displays the same advertisement image on that electronic advertisement apparatus.

Moreover, when the customer C views some chapters of the advertisement image on the electronic advertisement apparatus 2, if the viewer information recording apparatus 11 records up to which chapter the customer C has viewed, it is possible to display the remaining of the same advertisement image on the electronic advertisement apparatus 5.

That is, the electronic advertisement system 10 tracks the customer C moving in the store 1, and displays the advertisement image viewed by the customer C before moving on any one of the electronic advertisement apparatuses 2 to 5 where the customer C moves, so that the appeal power of the advertisement image to the customer C increases, thereby improving the advertisement effect.

In the embodiment, the explanation was given of an example case in which the advertisement image related to the advertisement image viewed by the customer C is the “same advertisement image”, but the “related advertisement image” of the present invention is not limited to the “same advertisement image”. For example, an advertisement image of a product belonging to the same category as that of the advertisement image viewed by the customer C on the electronic advertisement apparatus 2 may be displayed on the electronic advertisement apparatus 5. Moreover, an advertisement image of a product of the same brand may be displayed on the electronic advertisement apparatus 5. Furthermore, when, for example, the customer C viewed the image advertisement of a brand for a long time, the age and the gender of the customer C may be estimated based on the facial image of the customer C, and an advertisement image of a product of that brand appropriate for the age and the gender of the customer C may be displayed on the electronic advertisement apparatus 5. Alternatively, when plural advertisement images are in a series (e.g., plural advertisement images configure a successive story), a next advertisement image to the advertisement image viewed by the customer C on the electronic advertisement apparatus 2 may be displayed on the electronic advertisement apparatus 5. That is, the “related advertisement image” has any kind of relationship with the advertisement image viewed by the customer C on the electronic advertisement apparatus 2, and is selected by the advertisement distribution apparatus 13 in accordance with a predetermined program.

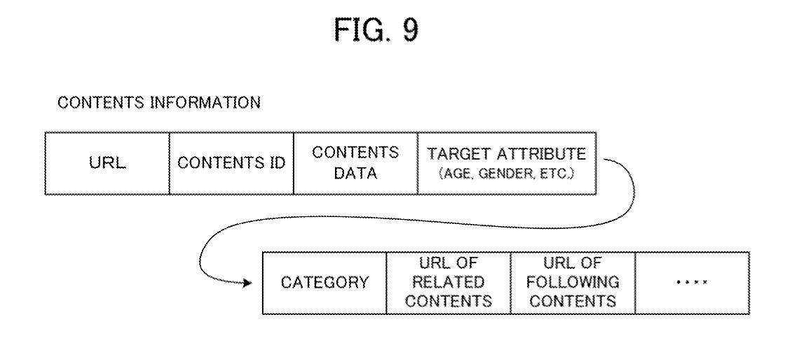

When performing such a process, for example, as shown in FIG. 9, the attribute of a customer which is a target of an advertisement, categories of an advertisement target product or service, the URL of a related advertisement, and the URL of a following advertisement image, etc., are stored in the contents data in association with one another, and a selection flag indicating which one is effective is set.

For example, the selection flag may be set in the attribute, the age and the gender of a customer may be determined based on a determined facial image, and an advertisement image having a target attribute set may be searched and distributed.

Likewise, the selection flag may be set in the category, the category of an advertisement image may be determined, and the advertisement image belonging to the same category as the determined category may be searched and distributed.

Moreover, the selection flag may be set in the related advertisement image, the URL of the related advertisement image may be specified, and an advertisement image may be read from the specified URL and distributed.

Furthermore, the selection flag may be set in a following advertisement image, the URL of the following advertisement image may be specified, and an advertisement image may be read from the specified URL and distributed.

In the embodiment, the electronic advertisement apparatus 5 displays the advertisement image, but the advertisement image is not limited to a motion image. It may be a still image.

Moreover, the advertisement image is not limited to an image that directly advertises a specific product or service. It may be an image advertisement for appealing a brand image, or may be an advertisement for notifying of holding a promotion event.

How to determine the sameness/difference of the facial images is optional, but such determination may be carried out by extracting characteristic data of a face from a facial image and comparing the extracted characteristic data with another characteristic data. The determination technique using characteristic data is one that is disclosed in, for example, Unexamined Japanese Patent Application KOKAI Publication No. 2004-139596.

The embodiment explained in this specification and shown in the accompanying drawings is merely an example embodiment of the present invention. Needless to say, the scope and the spirit of the present invention are not limited to the embodiment, and can be changed and modified within the scope and the spirit of the present invention set forth in the appended claims. For example, in the embodiment, in order to facilitate understanding, the facial image checking apparatus 12 and the advertisement distribution apparatus 13 are separate computers, but a computer may be configured to function as both facial image checking apparatus 12 and advertisement distribution apparatus 13. Moreover, some of or all of the function of the facial image checking apparatus 12 may be possessed by each of the electronic advertisement apparatuses 2 to 5.

The data structure and the process procedure of each device can be changed and modified as needed. For example, in the configuration shown in FIG. 3, instead of the facial image (or in addition to the facial image), characteristic data, etc., of a face obtained from the facial image may be used. Moreover, in the step S15 in FIG. 7, instead of waiting for the certain time by the timer TC, the process may be once terminated and repeated at a certain cycle, thereby determining whether or not the same facial image is obtained.

Moreover, the cameras 6 to 9 may pick up images of not only the facial part of the customer C but also arbitrary portion, such as the upper body, or the whole body of the customer C. Furthermore, the cameras 6 to 9 may be provided with a human detecting sensor, a heat detecting sensor, and an infrared sensor, etc. When such a sensor detects the customer C, the camera provided with that sensor may be activated in order to pick up an image of the customer C. The cameras 6 to 9 may pick up a still image at an arbitrary time interval (e.g., every 3 seconds). The facial image checking apparatus 12 can check a customer based on plural picked-up still images.

This application is based on Japanese Patent Application No. 2008-288285, and the whole specification, claims, and drawings of Japanese Patent Application No. 2008-288285 are herein incorporated by reference.

### LEGEND

1 Store
2 to 5 Electronic advertisement apparatuses
6 to 9 Cameras
10 Electronic advertisement system
11 Viewer information recording apparatus
12 Facial image checking apparatus
13 Advertisement distribution apparatus

1. An electronic advertisement system connected to a plurality of electronic advertisement apparatuses each of which displays an advertisement image, wherein
the electronic advertisement apparatus includes an image pickup unit that picks up an image of a viewer who views an advertisement image,
the electronic advertisement system comprises:
a viewer information recording unit that records an image of a facial part of a viewer picked up by the electronic advertisement apparatus, information for specifying an advertisement image viewed by the viewer, and information for specifying the electronic advertisement apparatus;
a facial image checking unit that checks an image of the facial part of the viewer with image information recorded in the viewer information recording unit when the electronic advertisement apparatus picks up an image of the viewer; and
an advertisement image control unit that causes another electronic advertisement apparatus to display an advertisement image related to an advertisement image viewed by a person of an image recorded in the viewer information recording unit when the facial image checking unit determines that the viewer picked up by the electronic advertisement apparatus is a same person as the person of the image recorded in the viewer information recording unit.

2. The electronic advertisement system according to claim 1, wherein the viewer information recording unit records an image of the facial part of the viewer, information for specifying an advertisement image viewed by the viewer, and information for specifying the electronic advertisement apparatus when the viewer views the advertisement image on the electronic advertisement apparatus over a predetermined time.

3. The electronic advertisement system according to claim 1, wherein
the advertisement image control unit
causes the electronic advertisement apparatus to display an advertisement image in accordance with a predetermined schedule, and
causes the electronic advertisement apparatus to display a same advertisement image as an advertisement image viewed by a person of an image recorded in the viewer information recording unit when the facial image checking unit determines that the viewer picked up by the electronic advertisement apparatus is a same person as the person of the image recorded in the viewer information recording unit, and
causes the electronic advertisement apparatus to display an advertisement image in accordance with the predetermined schedule when displaying of the same advertisement image ends.

4. An electronic advertisement distribution apparatus connected to a plurality of electronic advertisement apparatuses each of which displays an advertisement image, the electronic advertisement distribution apparatus comprising:
a viewer information recording unit that records an image of a facial part of a viewer of the electronic advertisement apparatus, information for specifying an advertisement image viewed by the viewer, and information for specifying the electronic advertisement apparatus;
a facial image checking unit that checks an image of the facial part of the viewer with image information recorded in the viewer information recording unit; and
an advertisement image control unit that causes another electronic advertisement apparatus to display an advertisement image related to an advertisement image viewed by a person of an image recorded in the viewer information recording unit when the facial image checking unit determines that the viewer picked up by the electronic advertisement apparatus is a same person as the person of the image recorded in the viewer information recording unit.

5. An electronic advertisement distribution method of distributing an electronic advertisement to a plurality of electronic advertisement apparatuses each of which displays an advertisement image, the electronic advertisement distribution method comprising:
a viewer information recording step of recording an image of a facial part of a viewer, information for specifying an advertisement image viewed by the viewer, and information for specifying the electronic advertisement apparatus;
a facial image checking step of checking an image of the facial part of the viewer with image information recorded in the viewer information recording step; and
an advertisement image control step of causing another electronic advertisement apparatus to display an advertisement image related to an advertisement image viewed by a person of an image recorded in the viewer information recording step when it is determined in the facial image checking unit step that the viewer picked up by the electronic advertisement apparatus is a same person as the person of the image recorded in the viewer information recording unit.

6. A computer-readable recording medium storing a program which is installed in a computer connected to a plurality of electronic advertisement apparatuses each of which displays an advertisement image, the program allowing the computer to function as:
a viewer information recording unit that records an image of a facial part of a viewer of the electronic advertisement apparatus, information for specifying an advertisement image viewed by the viewer, and information for specifying the electronic advertisement apparatus;
a facial image checking unit that checks an image of the facial part of the viewer with image information recorded in the viewer information recording unit; and
an advertisement image control unit that causes another electronic advertisement apparatus to display an advertisement image related to an advertisement image viewed by a person of an image recorded in the viewer information recording unit when the facial image checking unit determines that the viewer picked up by the electronic advertisement apparatus is a same person as the person of the image recorded in the viewer information recording unit.
